(19) United States
(12) Patent Application Publication
(10) Pub. No.: US 2026/0167050 A1
(43) Pub. Date: Jun. 18, 2026

(54) VEHICLE AND A METHOD FOR CONTROLLING THE SAME

(71) Applicants: HYUNDAI MOTOR COMPANY, Seoul (KR); KIA CORPORATION, Seoul (KR)

(72) Inventor: Seung Hyun Kim, Hwaseong-si (KR)

(73) Assignees: HYUNDAI MOTOR COMPANY, Seoul (KR); KIA CORPORATION, Seoul (KR)

(21) Appl. No.: 19/400,926

(22) Filed: Nov. 25, 2025

(30) Foreign Application Priority Data
Dec. 17, 2024 (KR) 10-2024-0188069

(51) Int. Cl. B60L 53/68; B60L 53/62; B60L 53/66; G06Q 10/02

(52) U.S. Cl. CPC B60L 53/68; B60L 53/62; B60L 53/66; G06Q 10/02

(57) ABSTRACT

A vehicle and a method for controlling the same efficiently manage the energy of a vehicle. A server includes a memory configured to store energy limit amount information of a destination, a communication unit configured to perform communication with a vehicle and a destination server. The server further includes a control unit configured to receive vehicle information including an energy state of the vehicle and destination information from the vehicle, compare an energy limit amount of the destination with the energy state of the vehicle, determine whether to store the energy of the vehicle at the destination, and transmit an energy storage request to the destination server based on a result of the determination.

### CROSS-REFERENCE TO RELATED APPLICATION

This application claims priority to and the benefit of Korean Patent Application No. 10-2024-0188069, filed on Dec. 17, 2024, the disclosure of which is incorporated herein by reference in its entirety.

### BACKGROUND

### 1. Field of the Disclosure

Various embodiments of the present disclosure relate to technology for efficiently managing the energy of a vehicle.

### 2. Discussion of Related Art

With the spread of electric vehicles, safety issues related to a state of charge (SOC) of the batteries for electric vehicles have emerged. In particular, due to concerns about the risk of fire of electric vehicles, some buildings impose battery charging and time limits for electric vehicles to charge and park. Accordingly, users have to find additional ways to meet different battery limits for each building, which is inconvenient.

In current systems, when electric vehicles exceed the battery limit amount imposed by the destination building, the electric vehicle may not be able to charge at the destination building. Therefore, the electric vehicle may have to consume battery energy before being able to charge at the destination building or to find another destination that meets the battery limit amount. This approach is not only inconvenient for the users but also inefficient since the efficiency of energy management is reduced.

### SUMMARY OF THE DISCLOSURE

The present disclosure has been made to solve the aforementioned problems and is directed to efficiently managing an energy state of a vehicle and energy constraints of a destination, e.g., a destination building, and an affiliate, e.g., an affiliate location configured to supply energy to the vehicle, wherein the amount of supplied energy is determined by a predefined policy based on previously stored energy.

The problems to be solved by the present disclosure are not limited to the problems that are mentioned above. Other problems that have not been mentioned may be clearly understood by those of ordinary skill in the art from the description below.

According to an aspect of the present disclosure, a server includes a memory configured to store energy limit amount information of a destination. The server further includes a communication unit configured to perform communication with a vehicle and a destination server. The server further includes a control unit configured to receive vehicle information including an energy state of the vehicle and destination information from the vehicle, compare an energy limit amount of the destination with the energy state of the vehicle, determine whether to store the energy of the vehicle at the destination, and transmit an energy storage request to the destination server based on a result of the determination.

In an embodiment, the control unit may be configured to calculate in advance the expected remaining energy of the vehicle upon arrival at the destination, and transmit the energy storage request based on the expected remaining energy exceeding the energy limit amount of the destination.

In an embodiment, the control unit may be configured to additionally receive a final energy state of the vehicle after the vehicle arrives at the destination and transmit the energy storage request when the final energy state exceeds the energy limit amount of the destination.

In an embodiment, the control unit may be configured to transmit reservation information including parking information for storing energy at the destination to the vehicle before transmitting the energy storage request to the destination server.

In an embodiment, the control unit may be configured to receive the data related to the completion of storage of energy from the destination server or the vehicle and calculate compensation energy for the vehicle based on the data related to the completion of storage of energy.

In an embodiment, the control unit may be configured to determine whether to supply compensation energy to the vehicle at a new destination based on at least one of the energy state of the vehicle, the compensation energy, and an energy storage device state at the new destination when receiving new destination information from the vehicle after the completion of the storage of energy.

In an embodiment, the control unit may be configured to transmit a compensation energy supply request to a new destination server based on a result of the determination.

In an embodiment, the compensation energy for the vehicle may be set to be supplied to the vehicle at the destination or another destination in proportion to an energy storage amount or according to a predefined compensation policy.

In an embodiment, the compensation energy for the vehicle may be set at a different rate for each destination.

In an embodiment, the control unit may be configured to transmit to the vehicle whether or not a new destination set by the vehicle is a destination capable of providing the compensation energy.

According to another aspect of the present disclosure, there is a provided a method for managing the energy of a vehicle in a server. The method includes receiving vehicle information including an energy state of the vehicle and destination information from the vehicle, comparing an energy limit amount of the destination with the energy state of the vehicle to determine whether to store the energy of the vehicle at the destination, and transmitting an energy storage request to the destination server based on a result of the determination.

In an embodiment, the method may further include calculating in advance expected remaining energy of the vehicle upon arrival at the destination, and transmitting the energy storage request based on the expected remaining energy exceeding the energy limit amount of the destination.

In an embodiment, the method may further include additionally receiving a final energy state of the vehicle upon arriving at the destination, and transmitting the energy storage request based on the final energy state exceeding the energy limit amount of the destination.

In an embodiment, the method may further include transmitting reservation information including parking information for storing energy at the destination to the vehicle before transmitting the energy storage request to the destination server.

In an embodiment, the method may further include receiving the data related to the completion of storage of energy from the destination server or the vehicle, and calculating compensation energy for the vehicle based on the data related to the completion of storage of energy.

In an embodiment, the method may further include determining whether to supply compensation energy to the vehicle at a new destination based on at least one of the energy state of the vehicle, the compensation energy, and an energy storage device state at the new destination when receiving new destination information from the vehicle after the completion of the storage of energy.

In an embodiment, the method may further include transmitting a compensation energy supply request to a new destination server based on a result of the determination.

In an embodiment, the compensation energy for the vehicle may be set to be supplied to the vehicle at the destination or another destination in proportion to an energy storage amount or based on a predefined compensation policy.

In an embodiment, the compensation energy for the vehicle may be set at a different rate for each destination.

In an embodiment, the method according to some aspects may further include transmitting to the vehicle whether or not a new destination set by the vehicle is a destination capable of providing the compensation energy.

### BRIEF DESCRIPTION OF THE DRAWINGS

The above and other objects, features and advantages of the present disclosure should become more apparent to those of ordinary skill in the art by describing various embodiments thereof in detail with reference to the accompanying drawings, in which:

FIG. 1 is a diagram illustrating a vehicle energy management system according to an embodiment;

FIG. 2 is a configuration diagram illustrating a vehicle according to an embodiment;

FIG. 3 is a configuration diagram illustrating a server according to an embodiment;

FIG. 4 is a sequence diagram showing an operation for managing the energy of the vehicle according to an embodiment;

FIG. 5 is a sequence diagram showing an operation for managing the compensation energy of the vehicle according to an embodiment;

FIG. 6 is a flowchart showing an operation for managing the energy of the vehicle in the server according to an embodiment; and

FIG. 7 is a flowchart showing an operation for managing the compensation energy of the vehicle in the server according to an embodiment.

### DETAILED DESCRIPTION OF VARIOUS EMBODIMENTS

Hereinafter, various embodiments of the present disclosure are described in detail with reference to the accompanying drawings.

However, the technical idea of the present disclosure is not limited to the several embodiments that are described but may be implemented in various different forms. One or more of the components in the embodiments may be selectively combined or substituted and used without departing from the scope of the technical idea of the present disclosure.

Further, terms (including technical and scientific terms) used in the embodiments of the present disclosure may be construed as having the same meaning as commonly understood by those of ordinary skill in the art to which the present disclosure belongs, unless explicitly and specifically defined and described. Such terms as those defined in a generally used dictionary may be interpreted as having meanings consistent with the context of the relevant field of art and should not be interpreted to have ideal or overly formal meanings unless explicitly defined in the present disclosure.

In addition, the terms used in the embodiments of the present disclosure are intended to describe various embodiments and are not intended to limit the present disclosure.

In the present specification, a singular form may include a plural form unless the context clearly indicates otherwise. When “at least one (or one or more) of A, B, and C” is described, this may include one or more of all combinations of A, B, and C.

In addition, terms such as “first,” “second,” “A,” “B,” “(a),” and “(b)” may be used to describe components in the embodiments of the present disclosure.

These terms are only intended to distinguish the component from other components, and do not limit the nature, order, or sequence of the component.

When a component is described as being “connected,” “coupled,” or “joined” to another component, this may include not only a case where the component is directly connected, coupled, or joined to the other component, but also a case where the component is “connected,” “coupled,” or “joined” to the other component by still another component between the component and the other component.

Further, when one component is described as being formed or disposed “on or under” another component, the term “on or under” includes not only a case in which two components are in direct contact with each other, but also a case in which one or more other components are formed or disposed between the two components. In addition, when the term “on or under” is expressed, this may mean not only an upward direction but also a downward direction with respect to one component.

When a component, device, element, part, unit, module or the like of the present disclosure is described as having a purpose or performing an operation, function, or the like, the component, device, or element should be considered herein as being “configured to” meet that purpose or to perform that operation or function. For example, a “processor configured to (or set to) perform A, B, and C” may mean a dedicated processor (e.g., an embedded processor) for performing a corresponding operation or a specifically configured processor (e.g., a central processing unit (CPU) or an application processor) which performs corresponding operations by executing one or more software programs or computer-executable instructions which are stored in a memory. Each “part”, “unit”, “module”, “component”, “device”, “element”, and the like may separately embody or be included with a processor and a memory, such as a non-transitory computer readable media, as part of the apparatus.

In various flowcharts of the present disclosure, at least some steps may be omitted, or the order of the steps may be changed. At least some of the various embodiments of the present disclosure may be performed at a specific point in time in each step of the flowchart. The various flowcharts of the present disclosure may be performed by at least one of a control device 100, a processor 130, or a vehicle 10. Further, redundant contents in the drawings of the present disclosure may be omitted.

Hereinafter, the embodiments are described in detail with reference to the accompanying drawings. In the following drawings, the same reference numerals are used throughout to designate the same or equivalent elements, even though the elements are shown in different drawings and redundant description thereof is omitted.

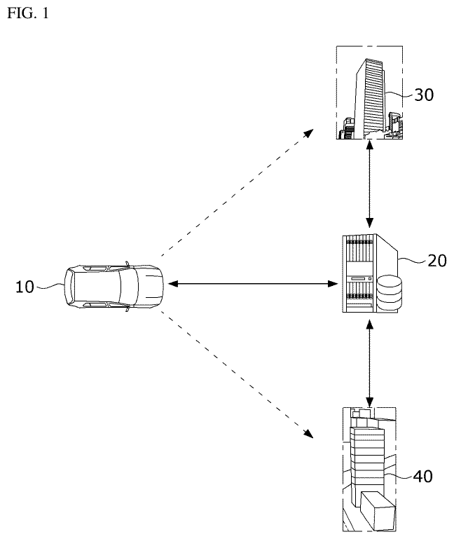

FIG. 1 is a diagram of a vehicle energy management system according to an embodiment. Referring to FIG. 1, the vehicle energy management system may include a vehicle 10, a server 20, a destination server 30, and an affiliate server 40. The vehicle energy management system efficiently manages energy and performs storage and compensation through a comparison of energy limit amount information of the destination server 30 and the affiliate server 40, based on an energy state (for example, battery charge level) and route information of the vehicle 10.

The vehicle 10 includes a communication unit that performs communication with the server 20, the destination server 30, and the affiliate server 40. The communication unit may transmit the battery state and the route information of the vehicle 10 to the server 20 or receive a storage/compensation command from the server 20. Further, the vehicle 10 may include a sensor that detects the energy state via measuring a battery charge level and temperature. The vehicle 10 may transmit the energy state to the server 20 through the communication unit. The vehicle 10 may store energy or execute a charging operation based on a command received from the server 20.

The vehicle 10 may be a battery-based electric vehicle (EV) that may store and release power. The vehicle 10 may also include a vehicle (for example, a fuel cell electric vehicle (FCEV)) that may store or convert energy using hydrogen energy. Further, the vehicle 10 may be a hybrid electric vehicle (HEV) or a plug-in hybrid electric vehicle (PHEV) in which an internal combustion engine is combined with a battery or fuel cell system.

The server 20 may act as an intermediary between the vehicle 10, the destination server 30, and the affiliate server 40. The server 20 may receive vehicle information including an energy state and destination information from the vehicle 10, receive energy limit amount information from the destination server 30, and compare the energy limit amount information with the energy state of the vehicle 10. Based on the vehicle information, the server 20 may determine whether or not energy storage is possible, and if necessary, generate an energy storage request or a compensation request and transmit the energy storage request or the compensation request to the destination server 30 or the affiliate server 40. Here, the energy storage request initiates the transfer of energy from the vehicle to the destination's energy storage device, whereas the compensation request initiates the supply of energy from the affiliate's energy supply device to the vehicle.

The destination server 30 may manage information about the energy limit amount of the destination (for example, destination building) at which the vehicle 10 will arrive and a state of the energy storage device(remaining space, constraints, and the like). When the destination server 30 receives the energy storage request, the destination server 30 may perform an operation of storing energy from the vehicle 10, record data on the stored energy, and then transmit the data to the server 20.

The affiliate server 40 may manage information about a place, i.e., an affiliate, which is defined as a location equipped with an energy supply system technically compatible with the server 20. At this affiliate, a vehicle 10 may receive a supply of energy after an energy storage operation, receive a supply of energy request data from the server 20, and provide information about an amount of energy available for supply, which is determined based on the energy storage amount of the vehicle 10 and in accordance with a predefined policy.

The energy storage device at the destination or affiliate serves to store the energy provided from the vehicle 10 and discharge the energy if necessary or manage the charging compensation based on the stored information. The energy storage device may be linked to the destination server 30 or the affiliate server 40 to manage the state in real time and may report an energy flow through communication with the vehicle 10 and the server 20.

The energy storage device may include a physical storage device and a separate control module. The physical storage device may include an energy storage medium such as battery cells and may be designed to store the energy provided from the vehicle 10. The storage device may support various types of energy and may include a configuration such as a capacitor. The storage device may be linked to the destination server 30 or the affiliate server 40 to update a current storage state (remaining capacity, maximum storage capacity, and the like) in real time. The storage device may receive the energy supplied from the vehicle 10 or supply the energy to the vehicle 10 based on an energy storage/supply request from a control unit of the destination server 30 or a control unit of the affiliate server 40.

A control module may control an energy storage and discharge process and monitor a real-time state. The control module may analyze data received from the vehicle 10 and the server 20, compare the remaining capacity of the storage with requirements, and start the energy storage or process a charging compensation procedure if necessary. The control module may also record the energy storage request and transmit state data of the storage to the server 20 and related servers 30 and 40 through its own communication module to support data synchronization in the overall system.

The vehicle 10 parked at the destination or the affiliate server and the energy storage device may interact through a physical connection and a communication connection. For example, the physical connection and the communication connection are possible through a charging connector that transmits power or data between the vehicle 10 and the energy storage device. However, the present disclosure is not limited thereto and the physical connection and the communication connection are possible in various forms.

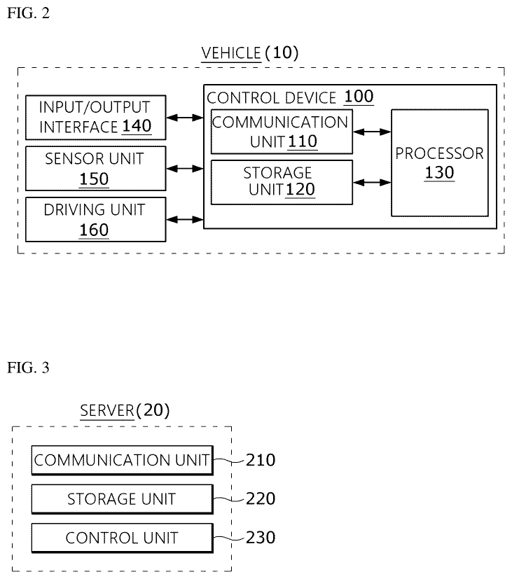

FIG. 2 shows a configuration diagram of the vehicle 10 according to an embodiment. The vehicle 10 may include the control device 100, a communication unit 110, a storage unit 120, the processor 130, an input/output interface 140, a sensor unit 150, and a driving unit 160. The control device 100, the communication unit 110, the input/output interface 140, the sensor unit 150, and the driving unit 160 may be implemented by one or more processors such as the processor 130.

The control device 100 may control internal components such as the communication unit 110, the storage unit 120, and the processor 130, and may be connected to various systems inside and outside the vehicle 10. The control device 100 may transmit or receive data through CAN communication, a wireless network, or a wired connection.

The communication unit 110 may support data transmission between components inside the vehicle 10 as well as communication with the external server 20, the destination server 30, and the affiliate server 40. The communication unit 110 may transmit or receive real-time data using various communication technologies such as Bluetooth, NFC, Wi-Fi, and a mobile communication network (5G, and the like).

The storage unit 120 may store driving data, energy state information, and communication data of the vehicle 10, and may include a combination of a nonvolatile memory and a volatile memory.

The processor 130 may be electrically or operatively connected to or coupled with the communication unit 110, the storage unit 120, the input/output interface 140, the sensor unit 150, and the driving unit 160 to process data and control the operation of the vehicle 10. The processor 130 may analyze driving environment data in real time and perform control of the vehicle 10.

The input/output interface 140 may receive inputs from a user and output state and system operation information of the vehicle 10.

The sensor unit 150 may detect driving and environmental information of the vehicle 10 in real time and may include sensors such as radar, LiDAR, ultrasonic sensors, and cameras.

The driving unit 160 provides driving power required for driving the vehicle 10 and may include an engine, a motor, a transmission, and a wheel drive system to control acceleration, deceleration, and direction changes of the vehicle 10.

FIG. 3 is a configuration diagram of the server 20 according to an embodiment.

The server 20 may include a communication unit 210, a storage unit 220, and a control unit 230. The server may additionally include an input/output interface for interaction with an administrator, although not shown. The communication unit 210, the control unit 230, and the input/output interface may be implemented by a processor of the server 20.

The communication unit 210 of the server 20 may transmit or receive data between the server 20 and the vehicle 10, and may provide a stable network connection through various communication technologies. The communication unit 210 may support short-range communication technology (Wi-Fi, Bluetooth, ZigBee, and the like) and include a mobile communication module based on a mobile communication network (2G, 3G, 4G, 5G, or the like) and a module for wireless Internet access to receive real-time data through long-range communication and a link with a cloud. The communication unit 210 may support various communication schemes including vehicle-to-vehicle (V2V) data communication, vehicle-to-infrastructure (V2I) communication, and vehicle-to-cloud (V2C) communication.

The storage unit 220 may store and manage data collected through communication with the vehicle 10, the destination server 30, and the affiliate server 40. The storage unit 220 may include a combination of a non-volatile memory (for example, a flash memory, an HDD, or an SSD) and a volatile memory (for example, a DRAM or an SDRAM), and may also include a cloud-based distributed storage system to support large-scale data processing. The storage unit 220 may be linked with a database system for efficient search and analysis of the collected data.

Further, the storage unit 220 may store the energy state of the vehicle 10, energy limit amount information received from the destination server 30 and the affiliate server 40, storage state information, and the like. The storage unit 220 may support the control unit 230 so that the control unit 230 performs energy storage and compensation procedures based on such information.

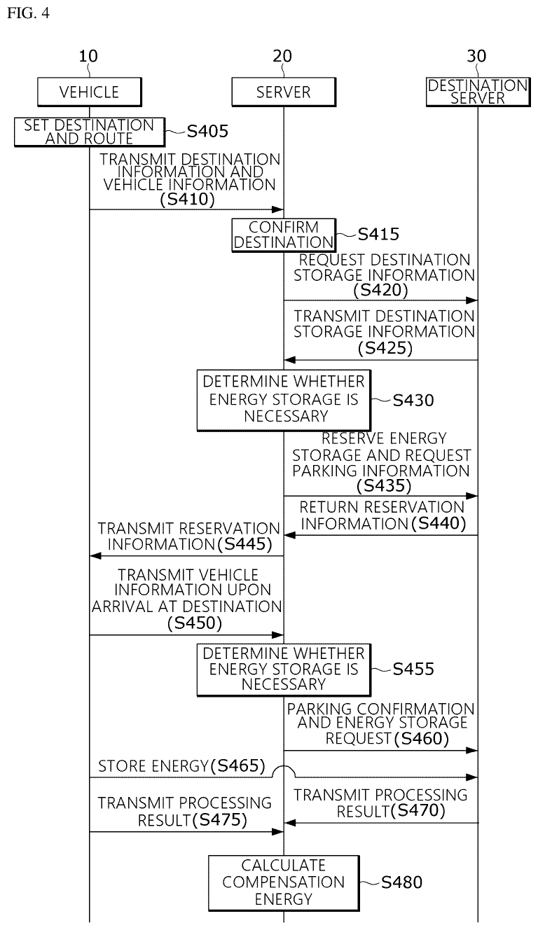

FIG. 4 is a sequence diagram showing an operation for managing the energy of the vehicle according to an embodiment.

The vehicle 10 may set a destination and a route through a user input or a navigation system (S405) and transmit the set destination information and vehicle information to the server 20 (S410).

According to an embodiment, the vehicle information may include at least one of a vehicle type, vehicle specifications, a current energy state (for example, battery charge level), a driving distance, driving environment data, and an expected energy state upon arrival at the destination. The current energy state may be generated based on data detected in real time by the sensor unit 150 inside the vehicle 10. The expected energy state upon arrival at the destination may be calculated in consideration of route data and driving conditions by the control device 100 inside the vehicle 10.

In this case, the expected energy state upon arrival at the destination may be determined not only by the vehicle 10, but also by the control unit 230 of the server 20 based on the data transmitted to the server 20.

According to an embodiment, the destination information may be information related to an initial destination transmitted from the vehicle 10 to the server 20. This destination information may include a name of the destination set by the vehicle 10, location coordinates (for example, latitude and longitude) of the destination, and route setting information (for example, expected driving distance, required time, and traffic conditions). For example, when the vehicle 10 sets a specific building as a destination through the navigation system, a name and location information of the building may correspond to the destination information transmitted to the server 20.

The server 20 may receive the destination information and the vehicle information transmitted from the vehicle 10 and confirm the destination of the vehicle 10 based on the destination information and the vehicle information (S415). The server 20 may analyze information such as destination coordinates or a name of the destination among the data transmitted from the vehicle 10 to identify a final destination of the vehicle 10.

According to an embodiment, the server 20 may receive the destination information and energy state data from the vehicle 10, and then, analyze nearby buildings to recommend another destination when energy storage is not possible at the destination. The recommended other destination (for example, a building) may be selected based on an expected remaining energy (for example, battery) state of the vehicle 10 and whether or not the building can store energy. The server 20 may transmit the recommended other destination to the vehicle 10 so that an alternative destination may be set.

The server 20 may request destination storage information from the destination server 30 based on the finally confirmed destination (S420) and receive the destination storage information from the destination server 30 (S425).

According to an embodiment, the destination storage information may include at least one of an energy limit amount of the destination, current energy storage device availability, an available storage amount, and additional constraints.

The destination server 30 may transmit a limit amount (for example, a maximum battery level allowed per vehicle) defined based on an energy management policy of the destination and available capacity information of a current energy storage device in response to a request from the server 20. Further, additional constraints (for example, storage limit policy for a peak time period) applied in a specific time period or under specific conditions may also be provided as the destination storage information.

The server 20 may determine whether the energy of the vehicle 10 should be stored in the energy storage device at the destination (S430). To this end, the server 20 may compare the energy state of the vehicle 10 received from the vehicle 10 with the energy limit amount of the destination received from the destination server 30. For example, the server 20 may compare a current battery charge level of the vehicle 10, an expected battery level after driving, and a maximum battery charge level (energy limit amount) allowed at the destination.

In this process, the server 20 may analyze the energy state data of the vehicle 10 to determine whether the expected remaining energy exceeds the energy limit amount of the destination. For example, when the expected remaining energy of the vehicle 10 exceeds the energy limit amount of the destination, the server 20 may determine that the vehicle 10 needs to store energy in the energy storage device.

On the other hand, when the expected remaining energy is within the energy limit amount, the vehicle 10 may arrive at the destination without additional energy storage.

According to an embodiment, the expected remaining energy may be determined by the vehicle 10. For example, the vehicle 10 may calculate an expected energy consumption amount to the destination based on a current battery charge state and route setting data and determine the expected remaining energy of the energy (for example, battery) upon arrival. The sensor unit 150 of the vehicle 10 may measure the battery level and real-time energy consumption data, and the navigation system may provide information such as a route distance, road slope, and traffic situation. The control device 100 of the vehicle 10 may integrate these items to predict the energy to be consumed while the vehicle 10 is driving, and calculate the expected remaining energy (for example, charge level) upon arrival at the destination.

According to an embodiment, an expected remaining charge level may be determined by the server 20. For example, the server 20 may determine the expected remaining energy of the vehicle 10 when the vehicle 10 arrives at the destination based on a current energy state (for example, a battery charge state), route information (for example, a distance to destination), and a vehicle specification (for example, a vehicle battery consumption rate) transmitted from the vehicle 10. The server 20 may utilize past driving data and real-time data of the vehicle 10 stored in the storage unit 220 and may calculate the expected energy consumption amount of the vehicle 10 by analyzing external factors such as traffic volume, external temperature, and road conditions.

For example, when the server 20 receives data “Current battery level: 60%,” “Distance to destination: 100 km,” and “Vehicle consumption rate: 18 kWh/100 km” from the vehicle 10, the server 20 may determine that the expected remaining charge level upon arrival at the destination is about 42%. The server 20 may compare the expected remaining charge level with the energy limit amount (for example, 70%) of the destination. When the expected remaining charge level is lower than the energy limit amount of the destination as a result of the comparison, the server 20 may determine that the vehicle 10 satisfies the destination limit. On the other hand, when the expected remaining charge level exceeds the limit level, the server 20 may determine that additional discharge of the vehicle 10 or energy storage in the energy storage device at the destination is necessary.

When the server 20 determines that energy storage is necessary, the server 20 may reserve the energy storage in the destination server 30 and request parking information required for the vehicle 10 (S435). The destination server 30 may provide reservation information, such as current energy storage device availability, an amount of energy that can be stored, an available parking space, and whether or not a parking reservation is made, to the server 20 (S440). The server 20 may confirm parking information such as a parking location suitable for the vehicle 10 based on such reservation information.

For example, the server 20 may transmit data including “Energy storage request: 10 kWh” and “Parking request” to the destination server 30, and the destination server 30 may return reservation information such as “Storable energy: Up to 15 kWh”, “Parking space: A-3”, and “Reservation status: Available” to the server 20 based on the data. In this process, the destination server 30 may analyze a current space situation of the parking lot and the availability of energy storage device in real time and respond to the server 20.

The server 20 may transmit the reservation information received from the destination server 30 to the vehicle 10 (S445).

The reservation information may include parking information. The parking information may include specific content required for the vehicle 10 to perform energy storage at the destination. For example, the parking information may include a location of a parking space (for example, space 3 in area A), an available parking time, a parking fee, and a way to connect to the energy storage device (for example, a location of a charging connector or whether or not wireless charging is possible).

When the vehicle 10 arrives at the destination, the vehicle 10 may transmit vehicle information including a current final energy state of the vehicle to the server 20 (S450). The vehicle information upon arrival at the destination may include data such as a location of the vehicle, the final energy state such as a final battery charge level upon arrival at the destination, whether or not parking is completed, and an energy storage readiness state.

For example, the vehicle 10 may transmit information such as “Current location: Destination parking space A-3”, “Current battery level: 80%”, and “Energy storage availability: Ready” to the server 20.

According to an embodiment, the server 20 may receive new vehicle information from the vehicle 10 that has arrived at the destination and then compare the energy limit amount of the destination with the final energy state of the vehicle 10 again based on the new vehicle information to determine whether to store the energy of the vehicle 10 at the destination (S455). Thus, the server 20 may reconfirm whether to store the energy based on the final data after the vehicle 10 arrives at the destination.

When a result of the reconfirmation shows that the energy of the vehicle 10 still needs to be stored in the destination storage, the server 20 may transmit a parking confirmation and energy storage request signal for the vehicle 10 to the destination server 30 (S460). The server 20 may generate the energy storage request signal based on the final energy state of the vehicle 10 and whether parking is completed, and this signal may include information such as an amount of energy to be requested to be stored, a parking location of the vehicle, and a scheme for connection to the storage.

For example, when the server 20 confirms that the battery level of the vehicle 10 is 50% and the energy limit amount of the destination is 30%, the server 20 may transmit a signal including data such as “Requested energy storage amount: 20%”, “Vehicle location: A-3”, and “Storage connection: Wired charging” to the destination server 30.

The destination server 30 may confirm a parking state of the vehicle 10 again after receiving the energy storage request signal from the server 20 and determine whether the energy storage device can handle the requested storage amount.

When a determination is made that the energy storage device can handle the requested energy storage amount, the energy of the vehicle 10 may be supplied to the energy storage device at the destination (S465). In this process, the vehicle 10 and the energy storage device may start energy transmission through a physical connection, and detailed information required for a storage process may be coordinated through the server 20 and the destination server 30.

Energy transfer may be performed through a wired scheme using a charging connector between the vehicle 10 and the energy storage device or through wireless charging technology. Further, a state (for example, a current storage capacity, transmission speed, and a voltage and current state) of the storage during energy transfer may be monitored in real time, and related data may be transmitted to the vehicle 10 and the server 20.

For example, when the vehicle 10 starts supplying the energy with a target of “Requested storage amount: 20 kWh”, the energy storage device may accumulate and record the transmitted energy and transmit state data such as “Storage completion: 20 kWh, and storage state: normal” to the server 20 and the destination server 30 when the storage process is completed.

When the supply of energy from the vehicle 10 to the energy storage device is completed, at least one of the destination server 30 and the vehicle 10 may transmit a processing result (for example, data related to energy storage completion) generated through the storage process to the server 20 (S470 and S475). The processing result may include detailed information such as whether or not storage of energy is completed, an actual amount of stored energy, a storage time, and a current state (for example, remaining capacity) of the storage.

For example, the vehicle 10 or the destination server 30 may transmit data such as “storage of energy completion,” “Amount of stored energy: 20 kWh,” “Storage time: 2:30 PM to 2:45 PM,” and “Remaining capacity of storage: 50 kWh” to the server 20. Such data may be recorded by the server 20 and utilized in energy management of the vehicle 10 and a compensation charging process at the affiliate thereafter.

The server 20 that receives the data related to the completion of storage of energy from at least one of the vehicle 10 or the destination server 30 may calculate compensation energy (i.e, an amount of energy to be supplied) for the vehicle 10 based on the received data (S480).

According to an embodiment, the compensation energy may be energy that is set to be supplied to the vehicle at the destination or another destination in proportion to the energy storage amount or according to a compensation policy defined in advance.

The server 20 may calculate the compensation energy suitable for the vehicle 10 based on information such as the amount of stored energy, a storage time, and a storage state transmitted from the vehicle 10 or the destination server 30.

For example, the server 20 may calculate the compensation energy for the vehicle 10 by applying a preset compensation policy or an agreement condition with the affiliate server 40, based on data such as “The amount of stored energy: 20 kWh”.

In a compensation calculation process, the server 20 may refer to an energy storage history of the vehicle 10 recorded in the storage unit 220 and compensation policy data of the affiliate server 40. Further, additional compensation may be applied, or compensation conditions may be adjusted depending on a specific time period or an operating policy of the affiliate.

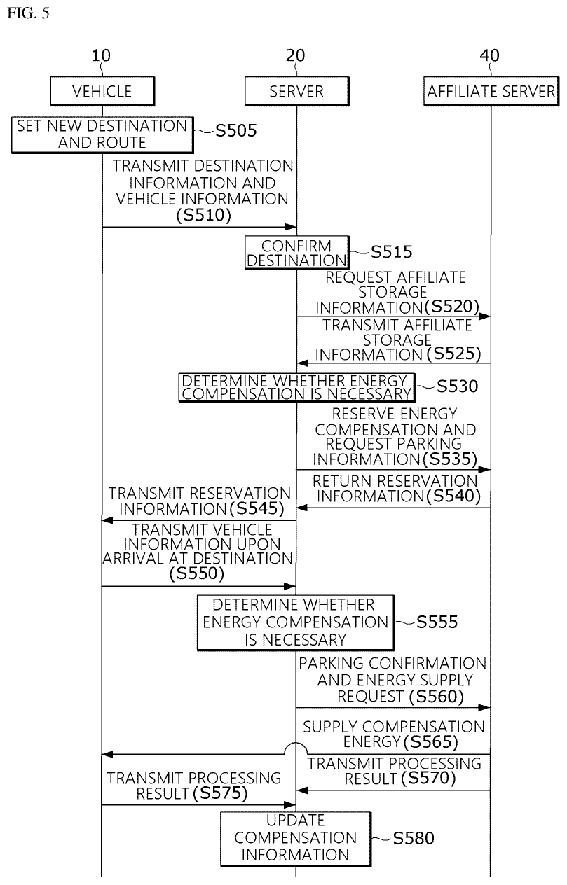

FIG. 5 is a sequence diagram showing an operation of managing the compensation energy for the vehicle according to an embodiment. The content already shown in FIG. 4 may be omitted in FIG. 5.

After the energy storage at the destination is completed, the vehicle 10 may set a new destination and route through a user input or the navigation system (S505). The new destination may be a general driving destination or may be an affiliate at which the vehicle 10 can receive compensation energy.

According to an embodiment, the vehicle 10 may confirm whether or not the destination is an affiliate and a compensation availability through communication with the server 20 in a route setting step. For example, when the vehicle 10 sets a specific new destination, the server 20 may inform the vehicle 10 whether the destination can connect to the affiliate server 40 and provide the compensation energy.

According to an embodiment, the server 20 may search for an affiliate building capable of providing charging compensation based on the compensation request data transmitted from the vehicle 10. In a search process, the server 20 may receive information such as current availability, available charging time, and a compensable energy amount from the affiliate server 40 and recommend an affiliate building suitable for the vehicle 10.

After the vehicle 10 sets a new destination, the vehicle 10 may transmit the vehicle information and information related to the route to the server 20 (S510). The vehicle information may include coordinates or a name of the new destination, an expected driving distance, a current battery charge state, vehicle specifications, and data related to a driving environment.

The server 20 may confirm the new destination based on the data transmitted from the vehicle 10 (S515). In this case, the description is given on the assumption that the new destination that has been selected is an affiliate.

The server 20 may request affiliate information from the affiliate server 40 at the affiliate based on the fact that the confirmed affiliate is an affiliate capable of providing compensation energy (S520). In this case, the server 20 may transmit the compensation energy amount and expected arrival time information of the vehicle 10 to the affiliate server 40.

After the affiliate server 40 processes the data requested from the server 20, the affiliate server 40 may transmit affiliate information, which includes a state of the affiliate and whether the affiliate can provide the compensation energy, to the server 20 (S525). In this case, the affiliate information may include current availability of a charging station at the affiliate, a compensable energy amount, a location of the charging station, and an available time period.

The server 20 may determine whether energy compensation for the vehicle 10 is possible based on the affiliate information received from the affiliate server 40 (S530). For example, when the server 20 receives information such as “Compensable energy amount: 20 kWh,” “Availability of charging station: Available,” and “Available time: 2 p.m. to 6 p.m.,” from the affiliate server 40, if an amount of compensation energy requested by the vehicle 10 is 15 kWh and an expected arrival time is 3 p.m., the server 20 may determine that the vehicle 10 may normally receive the compensation energy.

On the other hand, when the amount requested by the vehicle 10 exceeds the compensable energy amount (20 kWh) of the affiliate, or when the expected arrival time is outside of an available time (2 p.m. to 6 p.m.) of the affiliate, the server 20 may determine that compensation is not possible.

When compensation is possible, the server 20 may request a compensation request reservation and reservation information required for the vehicle 10 from the affiliate server 40 (S535), and may receive the reservation information from the affiliate server 40 (S540). The server 20 may transmit the received reservation information to the vehicle 10 (S545). The reservation information may include parking information as in the above-described destination.

Further, the vehicle 10 may transmit vehicle information upon arrival at the affiliate (S550), and the server 20 may confirm, for example, the final energy state of the vehicle 10 to re-confirm whether energy compensation is possible (S555).

For example, when the final battery level of the vehicle 10 matches an available compensation condition (for example, battery level of 40% or less) and the affiliate server 40 reports the availability of the charging station as “Normal,” the server 20 may determine that compensation is possible and start a compensation energy provision procedure.

The compensation determination process as described above is similar to the procedure at the destination, but a compensation policy and conditions of the affiliate server 40 may be additionally considered to determine the final compensation. According to an embodiment, the server 20 may determine a different energy compensation rate for each affiliate. For example, the server 20 may determine an energy compensation rate (that is, 1×) for an A affiliate to be a rate at which the vehicle 10 has been charged at an existing destination, and determine an energy compensation rate for a B affiliate to be a rate of 1.2× the amount by which the vehicle 10 has been charged at the existing destination.

When the reconfirmation result shows that compensation is possible, the server 20 may transmit a parking confirmation and energy compensation request signal for the vehicle 10 to the affiliate server 40 (S560). Thereafter, energy (for example, power) may be supplied from the energy storage device at the affiliate to the vehicle 10 under the control of the affiliate server 40 (S565). In this process, the affiliate server 40 may monitor the availability of the energy storage device and the state of charge of the vehicle 10 in real time and control the energy supply so that the energy supply is smoothly performed.

As described above, when the server 20 receives the new destination information from the vehicle 10 after storage of energy is completed, the server 20 may determine whether to supply compensation energy to the vehicle at the new destination based on at least one of the energy state of the vehicle, the compensation energy, and an energy storage device state at the new destination.

After the supply of compensation energy is completed, the affiliate server 40 may transmit a processing result to the server 20 (S570). The processing result may include data such as a final amount of compensation energy supplied to the vehicle 10, a required charging time, whether or not charging is completed, and a remaining state of the energy storage device. For example, results such as “Compensation energy supply completion: 15 kWh,” “Charging time: 20 minutes,” and “Remaining capacity of storage: 50 kWh” may be transmitted to the server 20.

Further, the vehicle 10 may transmit processing result data to the server 20 on its own (S575). The data transmitted from the vehicle 10 may include a final battery level after compensation is completed, a state during a charging process, and whether or not charging is completed. For example, information such as “Final battery level: 85%” and “State of charge: Normal” may be transmitted to the server 20.

The server 20 may compare and analyze the processing results received from the affiliate server 40 and the vehicle 10 to update compensation information of the vehicle 10 (S580). In a compensation information update process, an amount of supplied energy may be added to a compensation record of the vehicle 10, and the energy storage device state of the affiliate server 40 may be updated and utilized as data for a future compensation procedure.

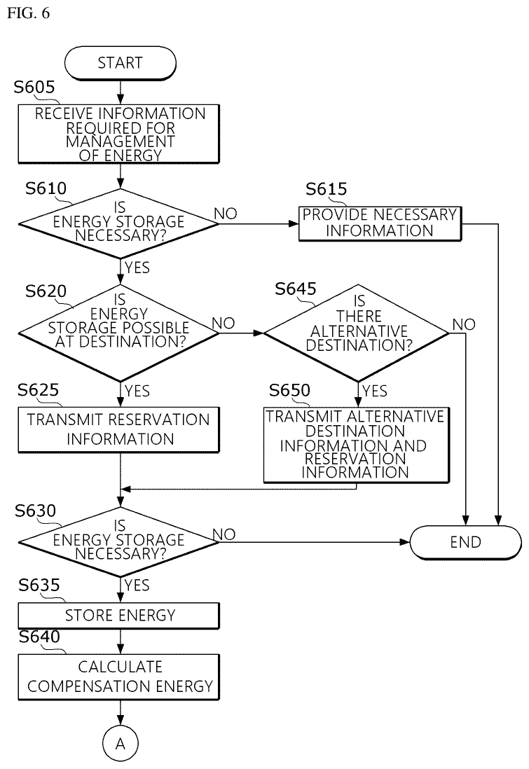

FIG. 6 is a flowchart showing an operation of managing the energy of the vehicle 10 in the server 20 according to an embodiment. The content already found in FIGS. 4 and 5 may be omitted in FIG. 6.

The server 20 may receive information required for management of the energy of the vehicle 10 and the destination from the vehicle 10 and the destination server 30 (S605). For example, the server 20 may receive vehicle information (for example, the current battery charge level, driving distance, and vehicle specifications) and destination information (for example, a name or coordinates of the destination) from the vehicle 10. Further, the server 20 may receive the destination storage information (for example, energy limit amount, storage availability, and parking availability) from the destination server 30.

The server 20 may determine whether it is necessary to store the energy of the vehicle 10 in the destination storage based on the received information (S610). For example, when the expected remaining energy of the vehicle 10 is lower than the energy limit amount of the destination, the server 20 may determine that it is not necessary to store the energy of the vehicle 10.

When it is not necessary to store the energy of the vehicle 10 (NO in S610), the server 20 may provide only the minimum necessary information to the vehicle 10 (S615). In this case, the necessary information may be route guidance to the destination or a guidance message upon arrival at the destination.

When the energy of the vehicle 10 is required to be stored in the destination storage (YES in S610), the server 20 may determine whether the destination storage may receive a certain amount of energy from the vehicle 10 (S620). The server 20 may evaluate whether storage is possible based on an available storage capacity, current availability, constraints of the storage, and the like included in the destination storage information.

When energy storage is possible in the destination storage (YES in S620), the server 20 may transmit reservation information to the vehicle 10 (S625). The reservation information may include a parking space location, an available parking time, a way of connection to the storage (for example, a wired charging connector or whether wireless charging is supported), and the like.

As illustrated in FIGS. 4 and 5, after the vehicle 10 arrives at the destination, the server 20 may receive final information from the vehicle 10 and re-confirm whether energy storage is necessary (S630). In this process, a final energy level of the vehicle 10 may be compared with a state of the destination storage again to finally determine whether storage is required.

When energy storage is not required, the operation in FIG. 6 may end. On the other hand, when energy storage is necessary (YES in S630), the server 20 may control the vehicle 10 so that the vehicle 10 can store energy in the destination storage, and storage may be performed through a physical connection between the vehicle 10 and the destination storage (S635).

When storage of energy is completed, the server 20 may calculate compensation energy for the vehicle 10 based on the amount of stored energy, the storage time, the storage state, and the like (S640). The calculation of the compensation energy may be performed based on the amount of energy stored in the destination storage and a predefined compensation policy.

On the other hand, when the energy storage is not possible in the destination storage (NO in S620), the server 20 may confirm whether there is an alternative destination where energy storage is possible (S645). In this case, the server 20 may additionally confirm storage information (for example, available storage capacity and parking availability) of the alternative destination to determine whether storage is possible.

When there is an alternative destination (YES in S645), the server 20 may receive reservation information from a server (not shown) of the alternative destination and transmit information about the alternative destination together with the reservation information to the vehicle 10 (S650). The reservation information may include parking information such as a parking location at the alternative destination, an available storage time, a storage scheme, and the like.

On the other hand, when there is no alternative destination (NO in S645), the operation in FIG. 6 may end, or the server 20 may transmit a new destination setting request to the vehicle 10. The vehicle 10 may set a new destination through a user input or may accept an alternative route suggested by the server 20 and move to the new destination.

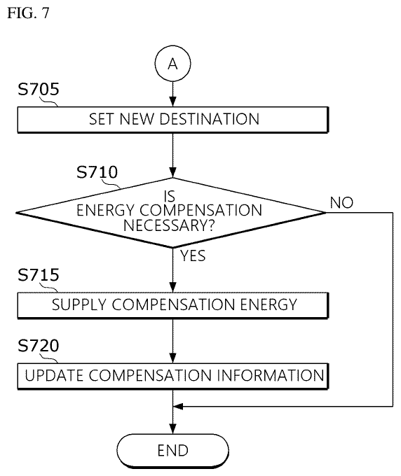

FIG. 7 is a flowchart showing an operation of managing the compensation energy for the vehicle 10 in the server 20 according to an embodiment. The content already shown in FIGS. 4-6 may be omitted in FIG. 7.

The server 20 may detect a new destination setting of the vehicle 10 (S705). In this process, the server 20 may analyze the destination information and the vehicle information received from the vehicle 10 to determine whether energy compensation related to the new destination is necessary (S710).

When a determination is made that the energy compensation is not necessary (NO in S710), the operation in FIG. 7 may end. In this case, the server 20 may transmit only the minimum route guidance information or related messages to the vehicle 10.

On the other hand, when a determination is made that energy compensation is necessary (YES in S710), the server 20 may transmit a signal for requesting energy compensation to the new destination, for example, the affiliate server 40 at the affiliate. The affiliate server 40 may confirm the energy storage device state at the affiliate and then perform control for the supply of energy to the vehicle 10 (S715). The energy supply may be performed through a wireless charging scheme or a wired charging connector.

After the energy supply is completed, the server 20 may receive the processing result from the affiliate server 40 and the vehicle 10 and update the compensation information for the vehicle 10 based on the processing results (S720). The compensation information may include an amount of supplied energy, a required charging time, whether or not charging is completed, and the like, and may be stored as data related to energy management of the vehicle 10 in the future.

The embodiments of FIGS. 1-7 described above, provide automation of the energy storage and a compensation process by efficiently managing the energy state of the vehicle 10 and the energy storage device state at the destination or the affiliate. The present disclosure relates to a technical solution that provides efficient distribution and storage of the energy of the vehicle 10 and achieves energy storage at the destination and compensation charging at the affiliate without additional input from the user.

The term “˜unit” used in various embodiments refers to a software or hardware component such as a field-programmable gate array (FPGA) or an ASIC, and the “˜unit” performs certain operations or functions. The “˜unit” may be configured to reside on an addressable storage medium or may be configured to operate one or more processors. Accordingly, for example, the “˜unit” includes components such as software components, object-oriented software components, class components, and task components, processes, functions, attributes, procedures, subroutines, segments of program code, drivers, firmware, microcode, circuits, data, databases, data structures, tables, arrays, and variables. Functions provided in the components and “˜units” may be combined into a smaller number of components and “˜units” or may be further separated into additional components and “˜units.” Further, the components and “˜units” may be implemented to operate one or more CPUs in a device or a secure multimedia card.

The embodiments of the present disclosure provide a technical solution to store surplus energy of the vehicle in the storage of the destination building and receive charging compensation at the affiliate building by efficiently managing the energy state of the vehicle and the energy constraints of the destination and the affiliate building.

The effects of the present disclosure are not limited to the effects mentioned above. Other effects that have not been mentioned may be clearly understood by those of ordinary skill in the art from the description.

Although the present disclosure has been described above with reference to various embodiments of the present disclosure, it should be understood by those of ordinary skill in the art that various modifications and changes may be made to the present disclosure without departing from the spirit and scope of the present disclosure set forth in the following claims.

What is claimed is:

1. A server comprising:
a memory configured to store energy limit amount information of a destination;
a communication unit configured to perform communication with a vehicle and a destination server; and
a control unit configured to receive vehicle information including an energy state of the vehicle and destination information from the vehicle, compare an energy limit amount of the destination with the energy state of the vehicle, determine whether to store the energy of the vehicle at the destination, and transmit an energy storage request to the destination server based on a result of the determination.

2. The server of claim 1, wherein the control unit is configured to calculate in advance expected remaining energy of the vehicle upon arrival at the destination and transmit the energy storage request based on the expected remaining energy exceeding the energy limit amount of the destination.

3. The server of claim 1, wherein the control unit is configured to additionally receive a final energy state of the vehicle after the vehicle arrives at the destination and transmit the energy storage request when the final energy state exceeds the energy limit amount of the destination.

4. The server of claim 1, wherein the control unit is configured to transmit reservation information including parking information for storing energy at the destination to the vehicle before transmitting the energy storage request to the destination server.

5. The server of claim 1, wherein the control unit is configured to receive data related to the completion of storage of energy from the destination server or the vehicle and calculate compensation energy for the vehicle based on the data related to the completion of storage of energy.

6. The server of claim 5, wherein the control unit is configured to determine whether to supply compensation energy to the vehicle at a new destination based on at least one of the energy state of the vehicle, the compensation energy, and an energy storage state at the new destination when receiving new destination information from the vehicle after the completion of the storage of energy.

7. The server of claim 6, wherein the control unit is configured to transmit a compensation energy supply request to a new destination server based on a result of the determination.

8. The server of claim 5, wherein the compensation energy for the vehicle is set to be supplied to the vehicle at the destination or another destination in proportion to an amount of stored energy or based on a predefined compensation policy.

9. The server of claim 5, wherein the compensation energy for the vehicle is set at a different rate for each destination.

10. The server of claim 5, wherein the control unit is configured to transmit to the vehicle whether or not a new destination set by the vehicle is a destination capable of providing the compensation energy.

11. A method for managing energy of a vehicle in a server, the method comprising:
receiving vehicle information including an energy state of the vehicle and destination information from the vehicle;
comparing an energy limit amount of a destination with the energy state of the vehicle to determine whether to store the energy of the vehicle at the destination; and
transmitting an energy storage request to a destination server based on a result of the determination.

12. The method of claim 11, further comprising:
calculating in advance expected remaining energy of the vehicle upon arrival at the destination; and
transmitting the energy storage request based on the expected remaining energy exceeding the energy limit amount of the destination.

13. The method of claim 11, further comprising:
additionally receiving a final energy state of the vehicle upon arriving at the destination; and
transmitting the energy storage request based on the final energy state exceeding the energy limit amount of the destination.

14. The method of claim 11, further comprising:
transmitting reservation information including parking information for storing energy at the destination to the vehicle before transmitting the energy storage request to the destination server.

15. The method of claim 11, further comprising:
receiving data related to the completion of storage of energy from the destination server or the vehicle; and
calculating compensation energy for the vehicle based on the data related to the completion of storage of energy.

16. The method of claim 15, further comprising determining whether to supply compensation energy to the vehicle at a new destination based on at least one of the energy state of the vehicle, the compensation energy, and an energy storage state at the new destination when receiving new destination information from the vehicle after the completion of the storage of energy.

17. The method of claim 16, further comprising transmitting a compensation energy supply request to a new destination server based on a result of the determination.

18. The method of claim 15, wherein the compensation energy for the vehicle is set to be supplied to the vehicle at the destination or another destination in proportion to an amount of stored energy or based on a predefined compensation policy.

19. The method of claim 15, wherein the compensation energy for the vehicle is set at a different rate for each destination.

20. The method of claim 15, further comprising transmitting to the vehicle whether or not a new destination set by the vehicle is a destination capable of providing the compensation energy.
